(19) United States
(12) Patent Application Publication
(10) Pub. No.: US 2010/0211610 A1
(43) Pub. Date: Aug. 19, 2010

(54) METHOD AND SYSTEM FOR MANAGING FINANCIAL TRANSACTION DATA

(75) Inventors: Naveen Ahuja, Gurgaon (IN); Lalit Chitkara, Faridabad (IN); Gaurav Duggal, Gurgaon (IN); Sanjeev Garg, Dwarka (IN); Amit Kapoor, Punjabi Bagh (IN); Tarun Paul, New Rajinder Nagar (IN); Shashi Srinivasan, Puram (IN)

Correspondence Address: Snell & Wilmer L.L.P. (AMEX), ONE ARIZONA CENTER, 400 E. VAN BUREN STREET, PHOENIX, AZ, 85004-2202, US

(73) Assignee: AMERICAN EXPRESS TRAVEL RELATED SERVICES COMPANY, INC., New York, NY (US)

(21) Appl. No.: 12/372,423

(22) Filed: Feb. 17, 2009

(51) Int. Cl. G06F 17/30

(52) U.S. Cl. 707/803; 707/E17.009

(57) ABSTRACT

The information related to a journal entry is gathered in a predefined format and a journal entry request is generated. The journal entry request is processed and the journal entry is recorded in a journal. Each individual associated with the journal entry request is automatically notified about any change in status of the journal entry request.

### FIELD OF INVENTION

The present invention generally relates to the field of accounting, and more specifically, to a method and system for managing financial transaction data.

### BACKGROUND

Accounting is a set of techniques used to record information related to financial transactions of an economic unit. Financial accounting facilitates generation of financial reports that enable external stakeholders to assess the performance of the economic unit. Similarly, managerial accounting enables internal decision makers to make sound decisions with regard to management of the economic unit.

Each event that affects the financials of the economic unit qualifies as a financial transaction and must be recorded in a journal. The journal is a chronological listing of the financial transactions undertaken by the economic unit. Typically, each financial transaction corresponds to a unique entry in the journal, which is referred to as a journal entry.

Often, an economic unit executes a large number of financial transactions on a daily basis, and consequently, a large number of journal entries are recorded in the journal. However, a journal entry typically needs to be validated before it is recorded in the journal.

In a conventional method, a requester generates a journal entry and sends a journal entry request to a processor. The journal entry request is sent through an email, along with one or more source documents. The processor is a person responsible for processing the journal entry requests. Once the journal entry request is sent to the processor, the processor compiles the journal entries, and checks details of the journal entries, such as approval requirement, compliance with journal entry rules, completeness of the journal entry, and source documents. If all these requirements are satisfied, the processor completes the processing of the journal entry request by entering the journal entry into a journal.

However, the conventional method needs manual processing of the journal entry requests which can result in several problems. For example, if the processor is not available, there is a possibility of missing some important requests by the requester. Further, there are chances of duplicate processing of the journal entry requests. This, in turn, can lead to serious errors in the journal, which will be difficult to identify and rectify at a later stage. Thus, the conventional method typically follows a tedious process including a considerable amount of manual efforts, and is prone to errors.

Moreover, in the conventional method, there is no standardized process to submit the journal entry request. The requesters submit the journal entry request in different formats, which further complicates the processing of the journal entry requests. Moreover, there is no mechanism for storing the journal entry requests made by the requesters. Thus, it is quite tedious and cumbersome to retrieve a journal entry request for reference in the future.

Furthermore, once the journal entry request is sent by the requester, typically no mechanism exists to check the status of the journal entry request, neither by the requester nor by any other stakeholder. For instance, in response to a journal entry request email from the requester being missed, the requester often will not know of this and will be under the impression that the journal entry request is being processed. Later, if the requester does not receive any confirmation regarding the journal entry request, the requester will have to enquire about the status journal entry request. Since the conventional method does not have any mechanism for storing the journal entry requests, the requester will have to make another journal entry request. This is a tedious process which results in wasted time and leads to dissatisfaction of the requester.

Therefore, there is need for an improved method and system for managing financial transaction data. The method and system should provide standardization of the generation and processing of the journal entry request along with a provision to store the journal entry requests for reference in the future.

### SUMMARY OF THE INVENTION

A method for managing financial transaction data is disclosed. In one embodiment, a requester prepares a journal entry corresponding to a financial transaction and provides information related to the journal entry, along with one or more source documents, in an accounting workflow. A journal entry request is prepared and submitted in the accounting workflow. A first notification is automatically generated and sent to an approver for approval of the journal entry request. The approver approves the journal entry request in the accounting workflow. In response to the journal entry request being approved by the approver, a second notification is automatically generated and sent to the requester and a processor. The processor processes the journal entry request and records the journal entry in a journal. In response to the journal entry request being processed, a third notification, indicating the completion of processing of the journal entry request, is automatically generated and sent to the requester and the approver.

A financial data management system for managing financial transaction data is also disclosed. In one embodiment, the financial data management system includes a client module, a server module, and a database. The client module is operatively coupled to the server module. The server module is, in turn, operatively coupled to the database. The client module gathers information related to a journal entry, along with one or more source documents, the server module generates a journal entry request and submits the journal entry request in an accounting workflow. Each journal entry request is assigned a status. The status of the journal entry request is modified during the course of processing of the journal entry request. In response to the status of the journal entry requesting changes, the server module sends notifications to a set of individuals associated with the journal entry request. The database stores the journal and the journal entry requests.

The journal entry requests are archived in the database and, if desired, may be retrieved in the future for reference. Further, the system standardizes the generation and processing of the journal entry requests. The system automates the financial data management system, and thereby, enhances controls on approvals and processing of the journal entry requests. Each individual associated with the journal entry request is automatically notified about a change in status of the journal entry request.

### BRIEF DESCRIPTION OF THE DRAWINGS

Various embodiments of the present invention will hereinafter be described in conjunction with the appended figures provided to illustrate and not to limit the present invention, wherein like reference numerals refer to identical or functionally similar elements throughout the separate views, and which, together with the detailed description below, are incorporated in and form part of the specification, and in which:

FIG. 1 illustrates a block diagram of a financial data management system, in accordance with an embodiment of the present invention;

FIGS. 2A to 2F illustrate exemplary user interfaces for generating a journal entry request, in accordance with an embodiment of the present invention;

FIG. 3 illustrates an exemplary user interface for approving a journal entry request, in accordance with an embodiment of the present invention;

FIGS. 4A and 4B illustrate exemplary user interfaces for processing a journal entry request, in accordance with an embodiment of the present invention;

FIG. 5 illustrates a flowchart of a method for managing financial transaction data, in accordance with an exemplary embodiment of the present invention; and

FIGS. 6A and 6B illustrate a flowchart of a method for managing financial transaction data, in accordance with another exemplary embodiment of the present invention.

### DETAILED DESCRIPTION OF THE INVENTION

The detailed description of exemplary embodiments of the invention herein makes reference to the accompanying drawings, which show embodiments by way of illustration and best mode, and not of limitation. While these embodiments are described in sufficient detail to enable those skilled in the art to practice the invention, it should be understood that other embodiments may be realized and that logical and mechanical changes may be made without departing from the spirit and scope of the invention.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention offers several advantages. The financial data management system provides a standardized approach for generating and processing the journal entry requests. The journal entry request is submitted in a predefined format and the information included in the journal entry request must comply with the rules of the financial data management system.

The present invention provides a database for storing journal entry requests received from multiple requesters. The journal entry requests are stored and archived in the database and any request can be retrieved at any point in time. Each individual associated with the journal entry request is automatically notified about a change in status of the journal entry request. Further, the present invention facilitates on-demand retrieval of status information of the journal entry request. Further, the present invention facilitates provision of information related to performance and quality metrics of the financial data management system.

In one embodiment, the system includes a user interface (UI), a software module, logic engines, numerous databases and computer networks. While the system may contemplate upgrades or reconfigurations of existing processing systems, changes to existing databases and business information system tools are not necessarily required by the present invention.

Briefly, while the description references specific technologies, system architectures and data management techniques, practitioners will appreciate that this description is but one embodiment and that other devices and/or methods may be implemented without departing from the scope of the invention. Similarly, while the description may reference or imply a user interfacing with the system via a personal computer user interface, practitioners will appreciate that other interfaces may include mobile devices, kiosks and handheld devices such as personal digital assistants.

In this document, terms such as ‘comprises’, ‘comprising’, ‘includes’, ‘including’, or any other variation thereof, are intended to cover a non-exclusive inclusion, such that a process, article, system or apparatus that comprises a list of elements does not include only those elements, but may include other elements not explicitly listed or inherent to such a process, article or apparatus. The term ‘another’, as used in this document, is defined as at least a second or more.

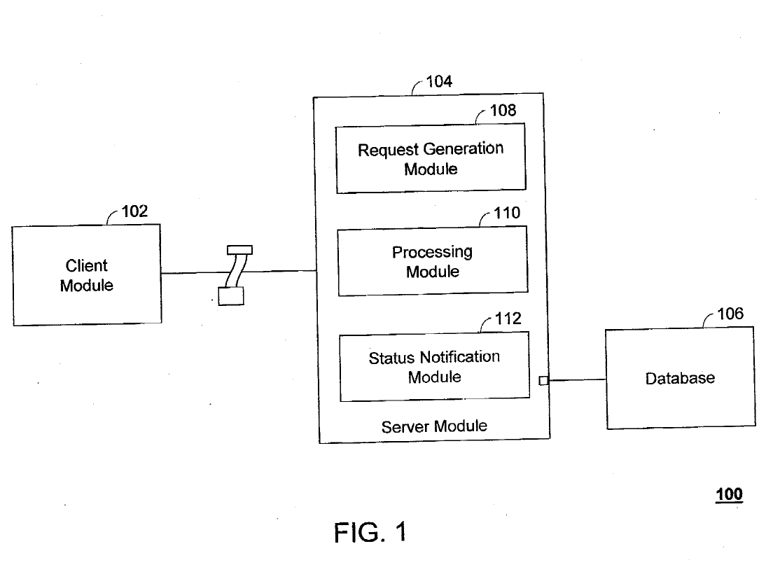

FIG. 1 illustrates a block diagram of a financial data management system 100, in accordance with an embodiment of the present invention. Financial data management system 100 includes a client module 102, a server module 104 and a database 106. Server module 104 includes a request generation module 108, a processing module 110, and a status notification module 112. In various embodiments, financial data management system 100 may be implemented in one of a variety of network architectures, such as, a 2-tier architecture (client-server architecture), a 3-tier architecture, an N-tier architecture, a peer-to-peer architecture, a tightly-coupled architecture, a service-oriented architecture, a mobile-code-based architecture, and a replicated-repository-based architecture.

Client module 102 is a client software application that facilitates information gathering from a requester and communication with server module 104. Client module 102 provides one or more user interfaces to various users of financial data management system 100. Examples of the users of financial data management system 100 include a requester, an approver, and a processor. Client module 102 is configured to gather information related to a journal entry, along with one or more source documents from a requester. Client module 102 is further configured to provide one or more user interfaces to an approver and a processor of the journal entry request.

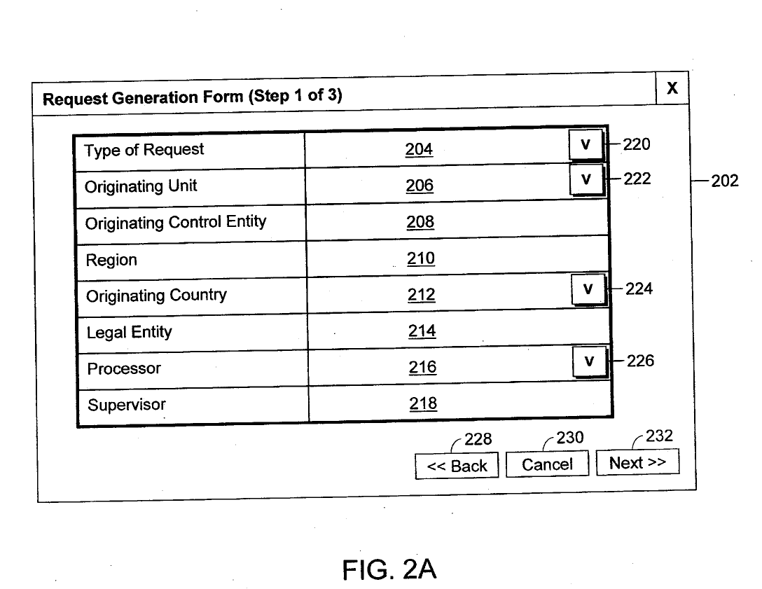

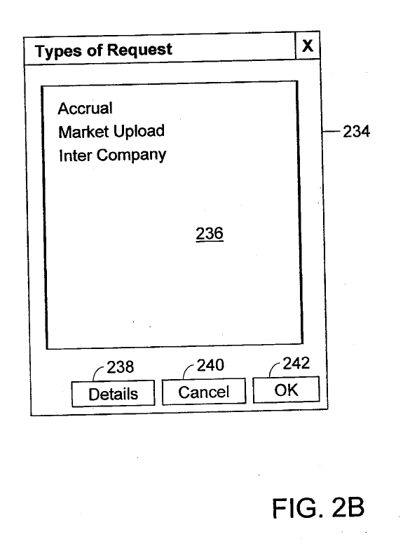

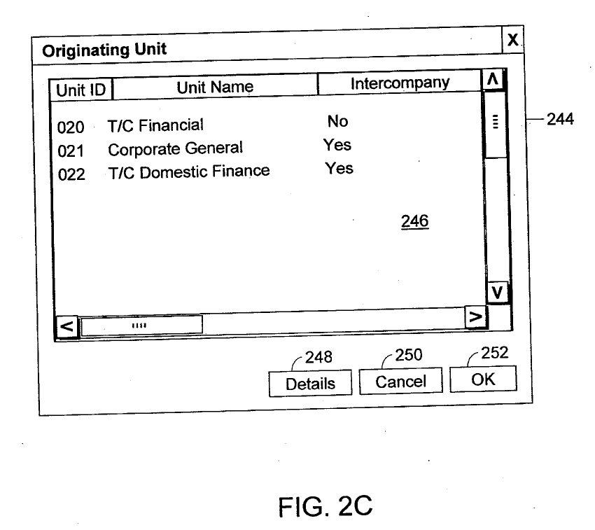

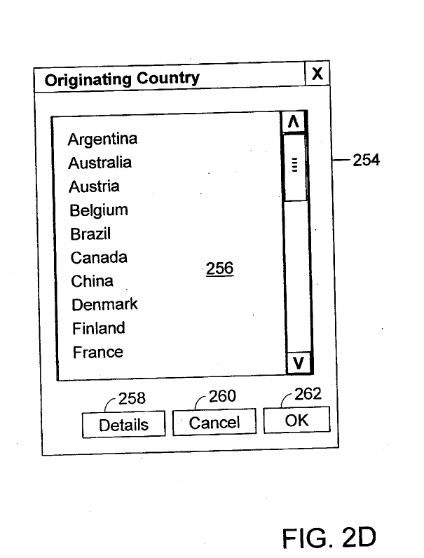

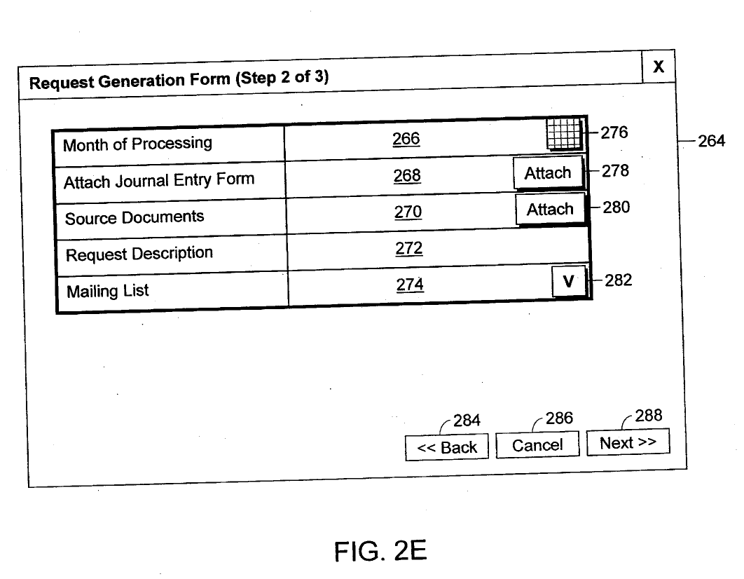

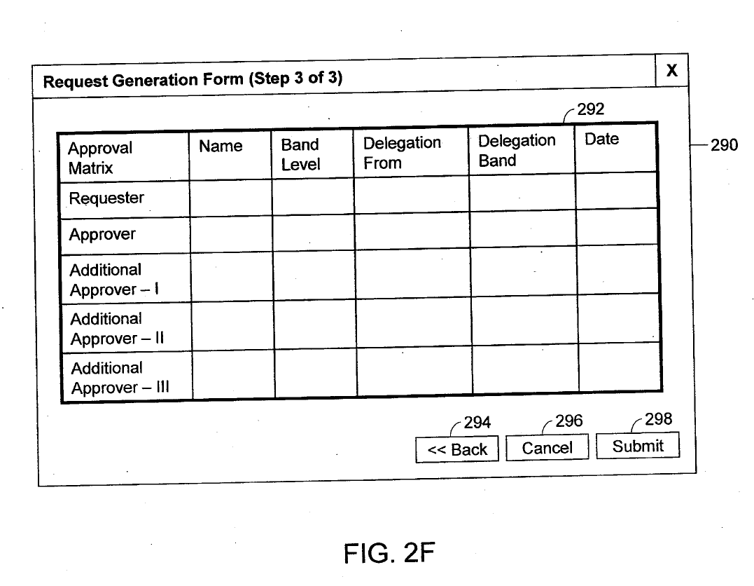

In an embodiment, client module 102 provides a user-interface as a form including multiple fields for providing information related to the journal entry request. The multiple fields may relate to one or more of general information related to the journal entry request, a journal entry, an approval cycle, and policy driven details. The general information related to the journal entry request includes details about type of request, originating unit, originating country, processor, and the like. The details relating to the journal entry include information, such as, a journal entry, source documents, detailed comments on the journal entry, the month in which journal entry should be processed, and the like. The details relating to the approval cycle include information related to name of an approver or a delegated person, band level, approval date, etc. The policy driven details include an undertaking about the accuracy of the journal entry details and confirmation about adherence to any requisite manual entry policy guidelines. Various user interfaces provided by client module 102 are explained in detail in conjunction with FIGS. 2-4.

In various embodiments, client module 102 is implemented on a general-purpose computational device, for example, a personal computer, a laptop, a palmtop, a personal digital assistant (PDA), a mobile cellular device, an Internet appliance, or any such device that has the communication, processing and display capabilities for performing the present invention.

In an embodiment, financial data management system 100 is based on the World Wide Web, which is a wide area hypermedia information retrieval system which includes a large set of interlinked Hypertext documents accessed through the Internet. Accordingly, the client software application includes a web client, server computational device includes a web server along with a database, the container data object includes a web page, and the external data object includes one of script files, style sheets, image files, audio files, video files, and so forth. While various embodiments may be described with reference to the client-server architecture of the Web, it should be noted that the present invention is equally applicable to any of the variety of architectures mentioned above.

Client module 102 may include an operating system (e.g., Windows XP, Windows NT, 95/98/2000, XP, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client module 102 may be in any environment with access to any network, including both wireless and wired network connections. In an embodiment, access is through a network or the Internet through a commercially available web-browser software package. Client module 102 and other system 100 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client module 102 is partially or fully connected to a network using a wired (“hard wire”) connection. As those skilled in the art will appreciate, Client module 102 and/or any of the system components may include wired and/or wireless portions.

Server module 104 is a server software application that provides various services to client module 102. In various embodiments, server module 104 may be implemented on a server computer, for example, a blade-server computer, a rack-mounted server computer, an entry-level server computer, and so forth.

Request generation module 108 receives the information input through one or more user interfaces provided to a requester by client module 102 in financial data management system 100. Request generation module 108 generates a journal entry request in the accounting workflow based on the received information. Request generation module 108 maintains a repository of rules of accounting workflow. In various, the rules of accounting workflow are defined in accordance with accounting standards prescribed by an international standards organization such as the International Accounting Standards Board (IASB) or the Financial Accounting Standards Board (FASB), as well as economic unit specific policy driven rules. Request generation module 108 may generate an error message if the information provided by the requester is not in accordance with the rules of accounting workflow.

Processing module 110 facilitates processing of the journal entry request. Processing module 110 assigns a status to the journal entry request and modifies the status of the journal entry request based on the processing of the journal entry request. Processing module 110 further facilitates generation of information related to quality and performance metrics to assess the performance of various users of financial data management system 100.

Status notification module 112 generates a status notification in response to the status of the journal entry request being modified. In an exemplary embodiment, one or more individuals associated with a journal entry request may request for a status update through client module 102. Status notification module 112 generates and sends a status notification to the one or more individuals.

Database 106 stores a journal that includes one or more journal entries corresponding to financial transactions of an economic unit. Various users interact with financial data management system 100 to record a journal entry, corresponding to a financial transaction, in database 106. Database 106 stores the journal entry requests sent from client module 102 to server module 104. In an embodiment, database 106 maintains information related to the life cycle of the journal entry request—from generation to various stages during the processing of the journal entry request, along with various notifications that are generated by server module 104 with regard to the journal entry request. Database 106 may be implemented using any suitable database for storing the one or more requests, for example, hierarchical databases, network databases, relational databases, entity databases, object databases, object-relational databases, and so on.

Database 206 provides a permanent memory location and may be implemented using any suitable database for storing the one or more data objects, for example, hierarchical databases, network databases, relational databases, entity databases, object databases, object-relational databases, and so on. Various examples of the data objects include web pages, script files, style sheets, image files, audio files, video files, and so forth. As practitioners will appreciate, while depicted as a single for the purposes of illustration, databases residing within financial data management system 100 may be implemented as separate and/or independent entities and represent multiple hardware, software, database, data structure and networking components. Furthermore, embodiments are not limited to the exemplary databases described herein, nor do embodiments necessarily utilize each of the disclosed databases.

Any database discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of financial data management system 100 may consist of any combination thereof at a single location or at multiple locations, wherein each database or system includes any of various suitable security features, such as firewalls, access codes, encryption, decryption, compression, decompression, and/or the like.

In one embodiment, client module 102, server module 104, and database 106 may be implemented using one or more computational devices. When implemented on different computational devices, client module 102 and server module 104 may be interconnected through a network. The network may span over one or more physical networks, such as Public Switched Telephone Network (PSTN), Integrated Services Digital Network (ISDN), cellular network, and so on. Examples of the network include a Local Area Network (LAN), a Wide Area Network (WAN), a wireless network, the Internet, and so forth.

In an embodiment, financial data management system 100 is based on the World Wide Web (hereinafter referred to as “the Web”), which is a wide area hypermedia information retrieval system which includes a large set of interlinked Hypertext documents accessed through the Internet. Accordingly, client module 102 is a web client, server module 104 is a web server, and the one or more user interfaces are stored in database 106 and rendered as web pages to client module 102.

FIGS. 2A to 2F illustrate exemplary user interfaces for generating a journal entry request, in accordance with an embodiment of the present invention. FIG. 2A illustrates a request generation form 202. Request generation form 202 includes multiple input fields, corresponding to general information related to the journal entry request, namely a type of request 204, an originating unit 206, an originating control entity 208, a region 210, an originating country 212, a legal entity 214, a processor 216, and a supervisor 218. Type of request 204 includes a button 220. Similarly, originating unit 206, originating country 212, and processor 216 include buttons 222, 224, and 226, respectively. Further, request generation form 202 includes a button 228, a button 230, and a button 232.

In various embodiments of the present invention, one or more of the input fields may be made mandatory such that the journal entry request generated based on the information provided by the requester is in conformance with a predefined format.

FIG. 2B illustrates a pop-up window 234. Pop-up window 234 includes a display area 236, a button 238, a button 240, and a button 242. The requester may click and select one of the types of requests from the list displayed in display area 236. The requester may click on button 238 to obtain additional information related to a type of request selected in display area 236. Further, the requester specifies a type of request to be input in type of request 204 by selecting button 242. The requester may close pop-up window 234 by selecting button 240.

FIG. 2C illustrates a pop-up window 244. Pop-up window 244 includes a display area 246, a button 248, a button 250, and a button 252. The requester may click and select one of the originating units from the list displayed in display area 246. The requester may click on button 248 to obtain additional information related to an originating unit selected in display area 246. Further, the requester specifies an originating unit to be input in originating unit 206 by selecting button 252. The requester may close pop-up window 244 by selecting button 250.

FIG. 2D illustrates a pop-up window 254. Pop-up window 254 includes a display area 256, a button 258, a button 260, and a button 262. The requester may click and select one of the originating countries from the list displayed in display area 256. The requester may click on button 258 to obtain additional information related to an originating country selected in display area 256. Further, the requester specifies an originating country to be input in originating country 212 by selecting button 262. The requester may close pop-up window 254 by selecting button 260.

FIG. 2E illustrates a request generation form 264. Request generation form 264 includes multiple input fields, corresponding to information related to the journal entry, namely, a month of processing 266, an attach journal entry form 268, a source documents 270, a description of request 272, and a mailing list 274. Month of processing 266 includes a button 276. Similarly, attach journal entry form 268, source documents 270, and mailing list 274 include buttons 278, 280, and 282, respectively. Further, request generation form 264 includes a button 284, a button 286, and a button 288.

FIG. 2F illustrates a request generation form 290. Request generation form 290 includes multiple input fields corresponding to information related to the approvers that are authorized to approve the journal entry request, namely fields corresponding to name, band level, delegation from, delegation band, and date for one or more approvers as well as the requester. The requester specifies his or her name, band level, and date. Further, the requester specifies name, band level, and date of the one or more approvers. In an embodiment, each approver is associated with a band level corresponding to the amount of financial transaction that he or she can approve. In case an approver is a person who has been delegated the role of approver by another approver, the corresponding details are mentioned under the delegation from and delegation band fields.

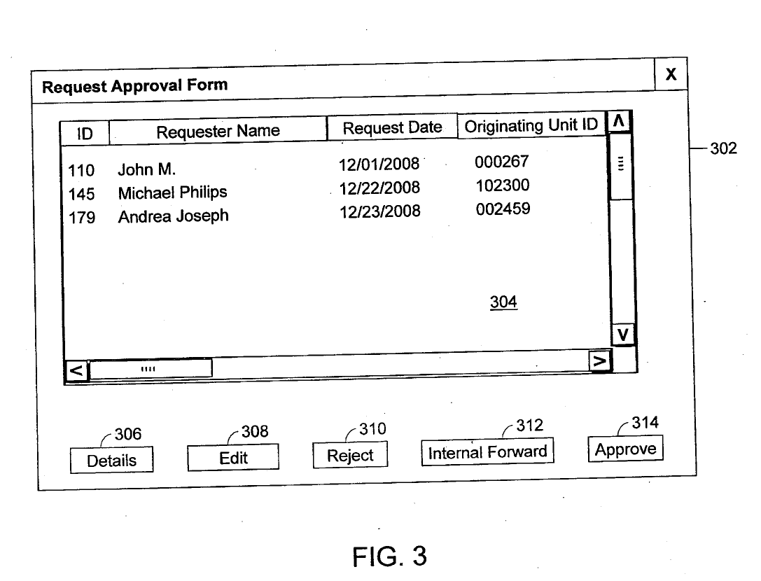

FIG. 3 illustrates an exemplary user interface for approving a journal entry request, in accordance with an embodiment of the present invention. Request approval form 302 includes a display area 304 and buttons 306 through 314.

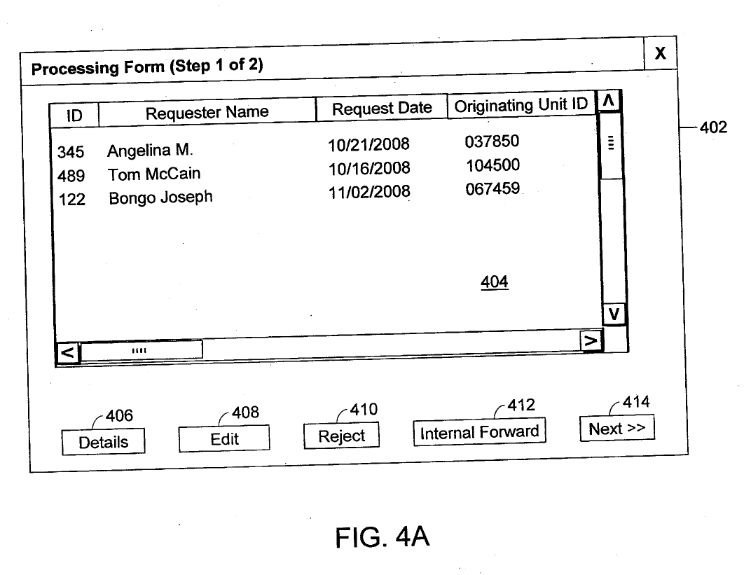

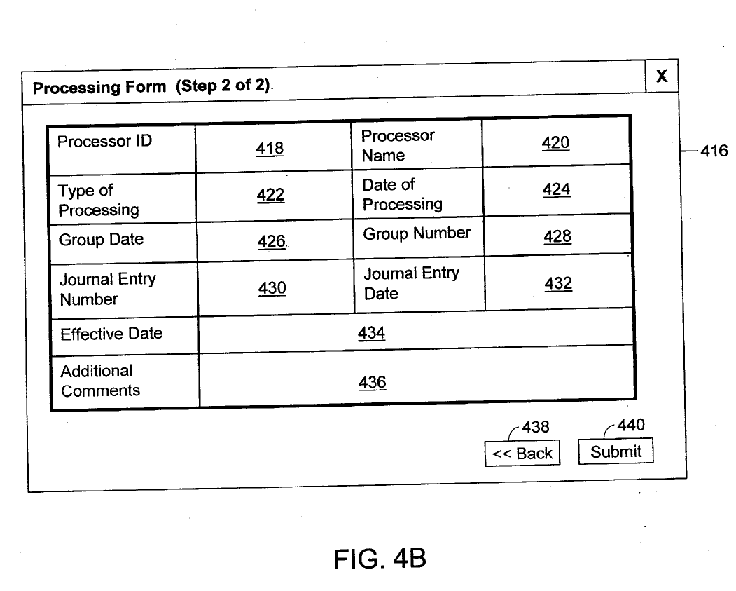

FIGS. 4A and 4B illustrate exemplary user interfaces for processing a journal entry request, in accordance with an embodiment of the present invention. Processing form 402 includes a display area 404, and buttons 406 through 414. In response to a processor accessing client module 102, all such requests for which he or she has been assigned and the ones which are approved are displayed in display area 404 of request approval form 402.

FIG. 4B includes processing form 416 includes multiple input fields, namely, processor id 418, processor name 420, type of processing 422, date of processing 424, group date 426, group number 428, journal entry number 430, journal entry date 432, effective date 434, and additional comments 436. Processing form 416 further includes buttons 438 and 440.

In addition to the components described above, financial data management system 100 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more financial data management system 100 components may be embodied as a customization of an existing system, an add-on product, upgraded software, a stand-alone system (e.g., kiosk), a distributed system, a method, a data processing system, a device for data processing, and/or a computer program product. Accordingly, individual financial data management system 100 components may take the form of an entirely software embodiment, an entirely hardware embodiment, or an embodiment combining aspects of both software and hardware. Furthermore, individual financial data management system 100 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall.

The system and method, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system includes a communication unit, which enables the computer to connect to other databases and the Internet through an I/O interface. The communication unit enables the transfer and reception of data from other databases and may include a modem, an Ethernet card, or any similar device, which enables the computer system to connect to databases and networks such as LAN, MAN, WAN and the Internet. The computer system facilitates inputs from a user through the input device that is accessible to the system through an I/O interface.

The computer system executes a set of instructions that are stored in one or more storage elements to process input data. The storage elements may also store data or other information, as desired, and may be in the form of an information source or a physical memory element present in the processing machine. Exemplary storage elements include a hard disk, a DRAM, an SRAM and an EPROM. Storage elements may also be external to the computer system, and be connected to or inserted into the computer, to be downloaded at or prior to the time of use. Examples of such external computer program products include computer-readable storage mediums such as CD-ROMS, flash chips, floppy disks, and the like.

Software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that directs a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Processing of input data by the processing machine may be in response to users' commands, to the result of previous processing, or in response to a request made by another processing machine. The modules described herein may include processors and program instructions that implement the functions of the modules described herein. Some or all the functions may be implemented by a state machine that has no stored program instructions, or in one or more application-specific integrated circuits (ASICs), in which each function or some combinations of certain of the functions are implemented as custom logic.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

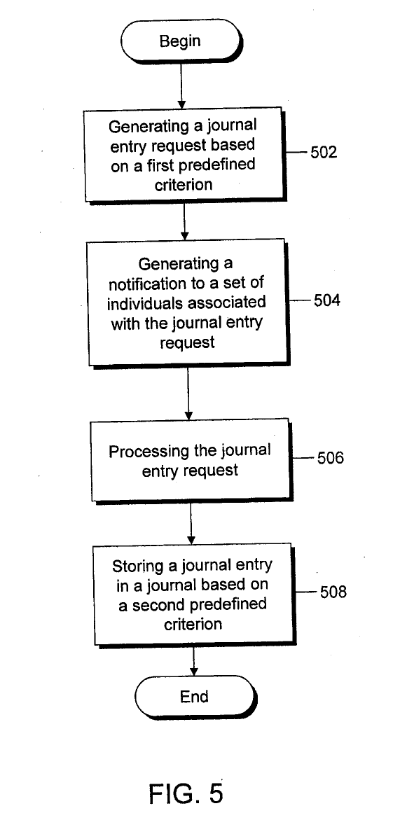

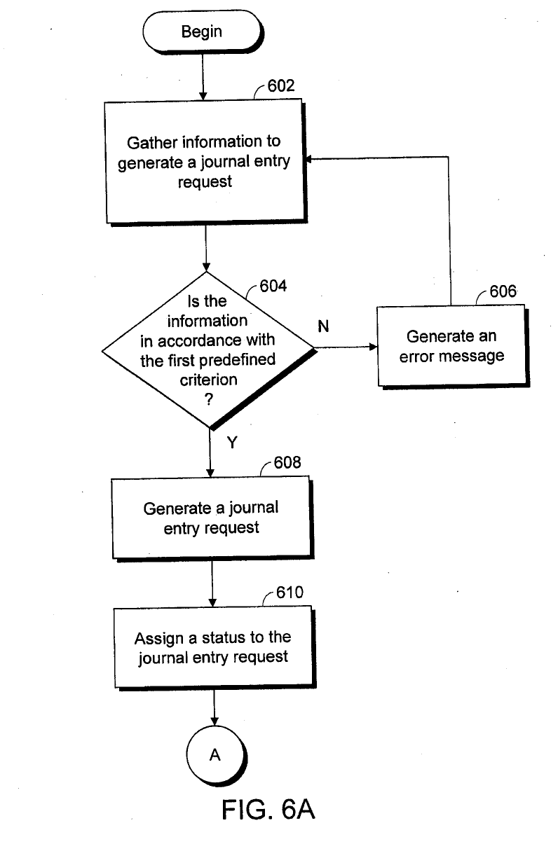

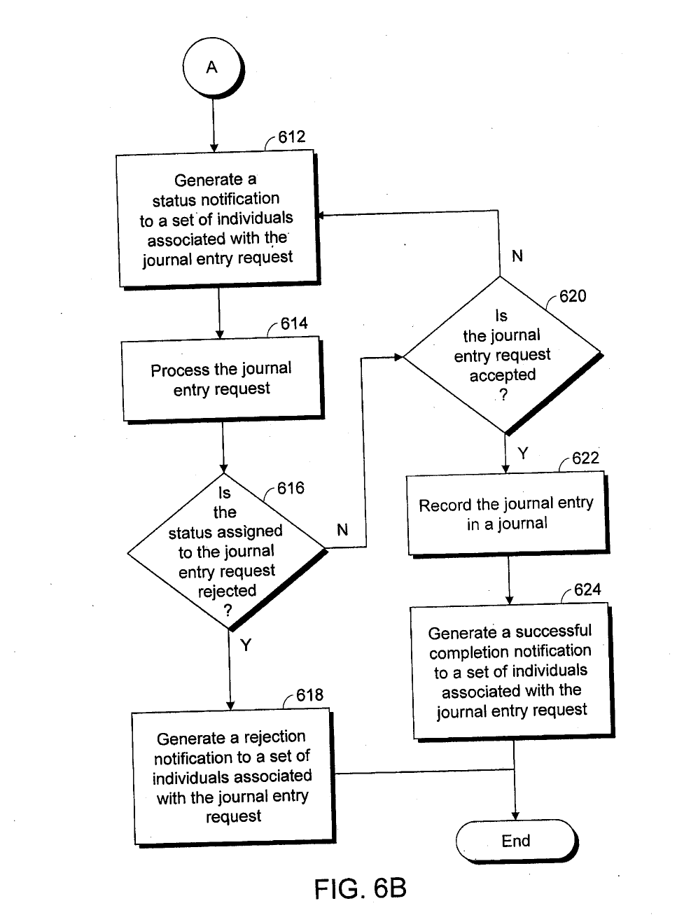

Referring again to the figures, the block system diagrams and process flow diagrams represent mere embodiments of the invention and are not intended to limit the scope of the invention as described herein. For example, the programming instructions and/or steps recited in FIGS. 5-6 may be executed in any order and are not limited to the order presented. It will be appreciated that the following description makes appropriate references not only to the steps depicted in FIGS. 5-6, but also to the various system components as described above with reference to FIGS. 1-4.

Referring now to FIG. 1, in an embodiment a requester accesses client module 102 and provides requisite information in a predefined format to generate a journal entry request for recording a journal entry, corresponding to a financial transaction, in the journal stored in database 106. Herein, recording the journal entry in the journal implies storing the journal entry in database 106. The requisite information includes a journal entry in a suitable format, such as a spreadsheet format, general information related to the journal entry and one or more source documents related to the journal entry. Client module 102 sends the information to request generation module 108.

Request generation module 108 generates the journal entry request based on the information provided by the requester. Request generation module 108 submits the journal entry request to processing module 110 which manages the accounting workflow. Processing module 110 stores the journal entry request in database 106 and assigns a status to the journal entry request which indicates that the request should be reviewed by an approver. Status notification module 112 automatically generates and sends a notification to an approver. In response to the approver accessing client module 102, client module 102 retrieves and displays the details of the journal entry request to be reviewed by the approver. In accordance with various embodiments of the present invention, the approver may reject or approve the journal entry request.

In response to the approver approving the journal entry request, processing module 110 modifies the status of the journal entry request to indicate that the request has been approved and should be reviewed by a processor. Status notification module 112 automatically generates and sends a notification to the requester and the processor. In response to the processor accessing client module 102, client module 102 retrieves and displays the details of the journal entry request to be reviewed by the approver. In an embodiment, the processor may either reject the journal entry request or process the journal entry request to post the journal entry to the journal based on the information included in the journal entry request. In response to the processor processing the journal entry request and records a journal entry in the journal, processing module 110 modifies the status of the journal entry request to indicate that the request has been processed by the processor. Status notification module 112 automatically generates and sends a notification to the requester and the approver indicating that the journal entry has been recorded in the journal.

If the journal entry request is rejected (e.g., by either the approver or the processor), processing module 110 modifies the status of the journal entry request to indicate that the request has been rejected. Status notification module 112 automatically generates and sends a notification to the requester indicating that the journal entry request has been rejected. The requester may re-submit the information related to the journal entry to generate a revised journal entry request.

FIGS. 2A to 2F illustrate representative user interfaces enabling journal entry request process, in accordance with an embodiment of the present invention. The requester inputs the type of request in type of request 204. The journal entry request may be related to ‘accruals’, ‘market uploads’, ‘inter-company transactions’, and so forth. In an embodiment, the requester selects the type of request from a drop-down menu by selecting button 220. In an embodiment, in response to the requester selection 220, a pop-up window is launched and the requester selects an appropriate type of request from a list displayed in the pop-up window (explained in detail in conjunction with FIG. 2B). In one embodiment, each type of request may be further categorized. For example, category ‘market upload’may have sub-categories, such as, ‘prepaid’, ‘tax’, ‘bank accounting’, ‘funding’, and so forth. The requester specifies one of the sub-categories.

The requester specifies a unit, in which the financial transaction was undertaken, in originating unit 206. In an embodiment, the requester selects the originating unit from a drop-down menu by selecting button 222. In an embodiment, in response to the requester selecting button 222, a pop-up window is launched and the requester selects an appropriate originating unit from a list displayed in the pop-up window (explained in detail in conjunction with FIG. 2C).

The requester specifies a control entity, which controls the unit specified in originating unit 206, in originating control entity 208. In an embodiment, server module 104 maintains a repository of hierarchy of various units within the economic unit and automatically populates originating control entity 208 in response to the requester specifying the unit in originating unit 206. Similarly, region 208 is also automatically populated in accordance with information maintained by server module 104.

The requester inputs a country name, in which the unit, specified in originating unit 206, is located. In one embodiment, the requester selects the originating country from a drop-down menu by selecting button 224. In an embodiment, in response to the requester selecting button 224, a pop-up window is launched and the requester selects an appropriate originating country from a list displayed in the pop-up window (explained in detail in conjunction with FIG. 2D). The legal entity 214 is also automatically populated in accordance with information maintained by server module 104.

The requester specifies a processor, an individual who is authorized to process the journal entry request, in processor 216. The requester selects the processor from a drop-down menu by selecting button 226. In an embodiment of the present invention, in response to the requester selecting button 226, a pop-up window is launched and the requester selects an appropriate processor from a list displayed in the pop-up window. In one embodiment, supervisor 218 is automatically populated in accordance with information maintained by server module 104 based on the processor specified in processor 216.

In response to the data corresponding to various input fields being specified, the requester selects button 232 to navigate to the next user interface for providing information related to generation of the journal entry request (explained in detail in conjunction with FIG. 2E).

Referring now to FIG. 2E, the requester inputs a month in which the journal entry is to be processed. In one embodiment, the requester selects button 276 to generate a calendar and selects a date from the calendar; month of processing 266 is populated accordingly.

The requester specifies a location of a journal entry form in attach journal entry form 268 and selects button 278. The journal entry form is retrieved from the specified location and attached with the journal entry request. Similarly, the requester specifies a location of a source document related to the financial transaction corresponding to the journal entry form. The source document is retrieved and attached with the journal entry request. In an exemplary embodiment of the present invention, the requester may attach multiple source documents in source documents 270.

The requester may provide detailed description of the journal entry request in description of request 272. In addition, the requester may specify the names of the individuals who should be informed about the status of the journal entry request. In an exemplary embodiment of the present invention, the requester selects names of persons from a drop down menu by selecting button 282.

In response to the data corresponding to various input fields being specified, the requester selects button 288 to navigate to the next user interface for providing information related to generation of the journal entry request (explained in detail in conjunction with FIG. 2F).

Referring now to FIG. 2F, once the general information relating to the journal entry request, the details relating to the journal entry, and the details related to the approvers are provided, the requester submits the information for generation of journal entry request. In response to the requester submitting the information, server module 104 determines whether the information provided by the requester conforms to the journal entry request generation requirements. In case the information conforms to request generation requirements, the journal entry request is successfully submitted. However, in case the requester has not provided correct and complete information, an error message, including the details of incomplete or incorrect information fields, is displayed to the requester. In another exemplary embodiment of the present invention, the verification of information is performed by client module 102 before dispatching the information to server module 104.

In response to the information related to journal entry request being successfully submitted, server module 102 generates a journal entry request and assigns a status to the journal entry request and stores the journal entry request in database 106. In an embodiment, the status assigned to the journal entry request is “pending approval.” Server module 104 automatically generates and sends a notification to the one or more approvers about the journal entry request. In one embodiment, the first notification is an email sent to the one or more approvers.

FIG. 3 illustrates an exemplary user interface for approving a journal entry request, in accordance with an embodiment of the present invention. In response to an approver accessing client module 102, all such requests for which he or she has been assigned as one of the approvers are displayed in display area 304 of request approval form 302. The approver can click and select a journal entry request and then, click button 306 to view the details of the journal entry request. In case the approver decides to reject the journal entry request due to some discrepancy, the approver can click on button 310 to reject the journal entry request. The journal entry request will be sent back to the requester for rectification of the defect. The status of the journal entry request is changed to ‘rejected’. Server module 104 sends a notification to the requester and other persons mentioned in mailing list 274.

The approver may click button 308 to edit one or more parts of the journal entry request. The approver may forward the journal entry request to another individual to transfer the journal entry request to the other individual by selecting button 312.

If the approver determines that all the information included in the journal entry request is in conformance with various rules and guidelines for submitting a journal entry in the journal, the approver approves the journal entry request by selecting button 314. Server module 104 changes the status of the journal entry request to ‘pending processing’. Server module 104 automatically generates and sends a notification to the processor mentioned in processor 216. Server module 104 also sends the notification to the requester and other persons mentioned in mailing list 274.

FIGS. 4A and 4B illustrate exemplary user interfaces for processing a journal entry request, in accordance with an embodiment of the present invention. The processor can click and select a request and can view the details of the request by clicking button 406. In case the processor decides to reject the request due to some discrepancy, he/she can click button 410 to reject the journal entry request. The journal entry request is sent back to the requester for rectification of the defect. The status of the request is changed to ‘rejected’. Server module 104 automatically generates and sends a notification to the requester and other persons mentioned in mailing list 274, and the one or more approvers assigned for the journal entry request.

The processor may click button 408 to edit one or more parts of the journal entry request. The processor may forward the journal entry request to another individual by selecting button 412. The processor forwards the journal entry request in case he or she is unable to process the journal entry request. For instance, if the processor is overloaded with work or if the processor is on leave or if the journal entry does not belong to a same group, etc., the processor can forward the journal entry request to another team member.

If the processor determines that all the information included in the journal entry request is in conformance with various rules and guidelines for submitting a journal entry in the journal, the processor navigates to the next user interface for processing the journal entry request by selecting button 414.

Referring now to FIG. 4B, the processor (also referred to as a “requester”) enters his or her identification number, name, type of processing, date of processing, date of the journal entry, number of the journal entry, effective date of processing the journal entry request, etc., in the multiple fields. Type of processing 422 may have a value of ‘complete’ or ‘partial’. If the journal entry request is not completely processed due to some discrepancies in the journal entry request, the processor sets the value of type of processing 422 to ‘partial’.

In response to the processor submitting the journal entry requests by selecting button 440, the journal entry is appropriately included in the journal stored in database 106. Server module 104 changes the status of the journal entry request to ‘pending processing’. Server module 104 automatically generates and sends a notification to the requester and other persons mentioned in mailing list 274 and the one or more approvers assigned for the journal entry request.

FIG. 5 illustrates a flowchart of a method for managing financial transaction data, in accordance with an exemplary embodiment of the present invention.

At step 502, a journal entry request is generated in accordance with an accounting workflow. At step 504, a notification is generated and sent to the set of individuals associated with the journal entry request. At step 506, one or more of the set of individuals who are assigned to process the journal entry request, process the journal entry in accordance with the accounting workflow. At step 508, if the journal entry request is in compliance with a set of rules of the accounting workflow, a journal entry corresponding to the journal entry request is stored in a journal.

FIGS. 6A and 6B illustrate a flowchart of a method for managing financial transaction data, in accordance with an embodiment of the present invention.

At step 602, an information set for generating a journal entry request for recording a journal entry is gathered from a requester in a predefined format. The requester is provided one or more user interfaces with a set of predefined input fields. The requester provides inputs corresponding to the set of predefined input fields.

The set of predefined input fields includes the input fields corresponding to a set of individuals that are assigned to process the journal entry request. The requester and the set of individuals that are assigned to process the journal entry request, along with one or more authorized representatives of such individuals, are collectively referred to as a set of individuals associated with the journal entry request.

At step 604, it is determined whether the information gathered from the requester is in compliance with a set of rules of an accounting workflow. If the information is not in compliance, then an error message is displayed to the requester at step 606. However, if the information is in compliance, then a journal entry request is generated at step 608.

At step 610, the journal entry request is assigned a status. For example, in response to the journal entry request being generated, it may be assigned a ‘pending approval’ status. In an embodiment, workflow logic checks all pending journal entry requests and posted journal entries to determine whether the journal entry request is a duplicate. Determining whether the request is a duplicate may be based upon a predetermined rule or criterion.

At step 612, a status notification is generated and sent to the set of individuals associated with the journal entry request. In an embodiment, in response to the journal entry request being assigned the ‘pending approval’ status, the status notification is automatically sent to one or more individuals assigned as approvers of the journal entry request.

At step 614, the journal entry request is processed. Further, the status of the journal entry request is modified based on the result of processing of the journal entry request. For example, the status that may be assigned to a journal entry request includes the following ‘pending approval’, ‘pending processing’, ‘rejected’, ‘accepted’, and ‘uploaded’.

In response to the journal entry request being in ‘pending approval’ status, an approver examines the information included in the journal entry request. The approver may either approve or reject the journal entry request based on the rules of accounting workflow. If the journal entry request is not in compliance with the set of rules of accounting workflow, the journal entry request is rejected. Accordingly, the status of the journal entry request is modified to ‘rejected’. However, if the journal entry request is in compliance with the set of rules of accounting workflow, the journal entry request is approved. Accordingly, the status of the journal entry request is modified to ‘pending processing’. In one embodiment, there are multiple approvers for a single journal entry request. The journal entry request is automatically routed to the multiple approvers either simultaneously or in a predetermined sequence. In an embodiment, a predefined approval hierarchy determines the approval decision in response to multiple approvers being involved.

Similarly, in response to the journal entry request being in ‘pending processing’ status, a processor examines the information included in the journal entry request. The processor may either approve or reject the journal entry request. If the journal entry request is not in compliance with the set of rules of accounting workflow, the journal entry request is rejected. Accordingly, the status of the journal entry request is modified to ‘rejected’. However, if the journal entry request is in compliance with the set of rules of accounting workflow, the journal entry request is accepted. Accordingly, the status of the journal entry request is modified to ‘accepted’.

At step 616, it is determined whether status of the journal entry request is ‘rejected’.

If the status of the journal entry request is not ‘rejected’, then it is determined if the status of the journal entry request is ‘accepted’ at step 620. If the status of the journal entry request is not ‘accepted’, then a status notification is generated at step 612. However, if the status of the journal entry request is ‘rejected’ at step 616, a rejection notification is sent to the set of individuals associated with the journal entry request at step 618.

At step 620, if the status of the journal entry request is ‘accepted’, then the journal entry is recorded in a journal at step 622. Accordingly, the journal entry is stored in the database. In an embodiment, the journal entry may be recorded manually by a processor of the journal entry request. In an embodiment, the journal entry may be automatically recorded in the journal. The status of the journal entry request is modified to ‘uploaded’. A successful completion notification is sent to the set of individuals associated with the journal entry request at step 624.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed.

While the steps outlined above represent specific embodiments of the invention, practitioners will appreciate that there are any number of computing algorithms and user interfaces that may be applied to create similar results. The steps are presented for the sake of explanation only and are not intended to limit the scope of the invention in any way.

The scope of the invention should be determined by the appended claims and their legal equivalents, rather than by the examples given above. Reference to an element in the singular is not intended to mean “one and only one” unless explicitly so stated, but rather “one or more.” Moreover, when a phrase similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method for managing financial transaction data, comprising:
generating, using a computer, a journal entry request in accordance with a first predefined criterion;
generating, using a computer, a status notification providing status information of the journal entry request;
transforming, using a computer, the journal entry request based on a status of the journal entry request to generate journal entry data; and
storing, using a computer, a journal entry corresponding to the journal entry data in a database in accordance with a second predefined criterion.

2. The method according to claim 1, further comprising receiving information related to the journal entry request.

3. The method according to claim 2, wherein the receiving information comprises providing one or more user interfaces, each user interface comprising a set of input fields.

4. The method according to claim 1, wherein the transforming the journal entry request comprises modifying the status of the journal entry request.

5. The method according to claim 1, wherein the transforming the journal entry request comprises identifying a set of individuals associated with the journal entry request.

6. The method according to claim 1, wherein the transforming the journal entry request further comprises: providing the journal entry data to a first reviewer and receiving a first approval decision for the journal entry from the first reviewer.

7. The method according to claim 6, wherein the journal entry data is automatically routed to a reviewer interface accessible by the first reviewer.

8. The method according to claim 6, wherein the transforming the journal entry request further comprises: providing the journal entry data to a second reviewer and receiving a second approval decision for the journal entry from the reviewer.

9. The method according to claim 8, further comprising determining an approval hierarchy based upon a third predefined criterion and automatically determining a final approval decision based upon the approval hierarchy and at least one of the first approval decision or the second approval decision.

10. The method according to claim 1, wherein the first predefined criterion is based upon at least one of a federal regulation or an accounting standard.

11. The method according to claim 1, wherein the first predefined criterion comprises checking at least one of a pending journal entry request or posted journal entries to determine if the journal entry request is a duplicate.

12. The method according to claim 1, wherein the status notification is generated based on a modification in the status of the journal entry request.

13. The method according to claim 1, wherein the status notification is automatically generated in response to a modification in the status of the journal entry request.

14. The method according to claim 1, wherein the status notification includes a unique tracking number associated with the journal entry request.

15. The method according to claim 1, wherein the generating a status notification providing status information occurs in response to at least one of: receiving a status request comprising a journal entry request identifier, receiving a status request comprising a processor identifier, a predefined schedule for the status notification, or a timeframe elapsing.

16. The method according to claim 1, further comprising storing the journal entry request in a database.

17. The method according to claim 1, further comprising generating information related to quality and performance metrics.

18. A method for tracking a journal entry request, comprising:
submitting, using a computer, a journal entry request in accordance with a first predefined criterion;
receiving, using the computer, a status of the journal entry request, wherein the status is generated, by a journal entry request system that validated the journal entry request; and
receiving, using the computer, a notification of a journal entry posting based upon the journal entry request, wherein the journal entry is generated by the journal entry request system based upon a second predefined criterion.

19. The method according to claim 18, wherein the receiving a status occurs in response to at least one of submitting a request for status, a predefined rule, a user profile, or a status notification parameter included in the journal entry request.

20. The method according to claim 18, wherein the receiving a status comprises receiving information related to the reasons that the journal entry request has been denied.

21. A computer-readable medium having stored thereon a plurality of instructions, the plurality of instructions comprising:
instructions to generate a journal entry request in accordance with a first predefined criterion;
instructions to generate a status notification providing status information of the journal entry request;
instructions to transform the journal entry request based on a status of the journal entry request to generate journal entry data; and
instructions to store a journal entry corresponding to the journal entry data in a database in accordance with a second predefined criterion.

22. A financial data management system, comprising:
a memory for storing a computer program;
and a processor coupled to said memory for executing said computer program,
wherein said computer program is configured to:
generate a journal entry request in accordance with a first predefined criterion;
generate a status notification providing status information of the journal entry request;
process the journal entry request based on a status of the journal entry request to generate journal entry data; and
store a journal entry corresponding to the journal entry data in a database in accordance with a second predefined criterion.
